(19) United States
(12) Patent Application Publication
(10) Pub. No.: US 2013/0310622 A1
(43) Pub. Date: Nov. 21, 2013

(54) Catalytically Active Material for the Hydrogenation Treatment of Hydrocarbons

(71) Applicants: Raimond L. C. Bonne, Amersfoort (NL); Olga Gonsiorová, Litvinov (CZ); Hans-Heino John, Halle (DE)

(72) Inventors: Raimond L. C. Bonne, Amersfoort (NL); Olga Gonsiorová, Litvinov (CZ); Hans-Heino John, Halle (DE)

(73) Assignee: EURO SUPPORT CATALYST GROUP B.V., Amersfoort (NL)

(21) Appl. No.: 13/979,146

(22) PCT Filed: Jan. 18, 2012
(86) PCT No.: PCT/EP2012/050688

§ 371 Date: Aug. 8, 2013

(30) Foreign Application Priority Data
Jan. 19, 2011 (EP) 11151421.2

(51) Int. Cl. B01J 27/185; B01J 23/883; B01J 23/78

(52) U.S. Cl. CPC B01J 27/1853; B01J 23/78; B01J 23/883
USPC 585/823; 502/243

(57) ABSTRACT

A catalytically active material having adsorption properties is used for the hydrogenation treatment of hydrocarbons severely contaminated with inorganic constituents.

The invention relates to a novel catalytically active material with adsorption properties for the hydrogenation treatment of hydrocarbons heavily contaminated with inorganic constituents and processes for the production thereof. The material according to the invention makes it possible, from any hydrocarbon-bearing waste flows, crude oil, hydrocarbon flows of natural or synthetic origin, which are particularly severely contaminated with inorganic components and heteroatom compounds, by hydrogenating conversion of disturbing metal and heteroatom compounds and immediate fixing of the foreign atom compounds liberated by hydrogenation and absorption of further dirt particles, colloidally disperse substances and catalyst poisons, to protect the main catalyst for the hydrogenation of the hydrocarbon flows.

### TECHNICAL FIELD

The components of such hydrocarbon fractions which are severely contaminated with inorganic constituents are detrimental to the catalysts used in the hydrogenation treatment of the hydrocarbons. They are deposited in the catalyst bed and as a result impede the passage through the reactor. That can lead to premature shutdown of the installation and the need to change the catalyst. Some damaging components in the hydrocarbons are present in the form of chemical compounds dissolved in the hydrocarbon flow and cannot be filtered out of that hydrocarbon flow.

Those dissolved compounds include compounds of phosphorus, arsenic and metallorganic compounds, for example of nickel and vanadium. They pass with the hydrocarbon flow to a sulphur-resistant hydrogenation catalyst which generally comprises compounds of elements of group VIB and/or VIIIB of the periodic table of elements, combined with a porous support, and adversely affect the hydrogenation function thereof. That also leads to premature poisoning of the hydrogenation catalyst, shutdown of the installation and catalyst change.

Particularly in the process of hydrogenation treatment of used engine oils, such detrimental phenomena occur. Those engine oils contain relatively large amounts of zinc, phosphorus and calcium compounds which were added to the engine oils as additives for improving the lubricating properties and oxidation stability. Due to the long period of use of the oils they are also contaminated with small amount of iron, chromium, copper and other metal compounds which can also get on to and damage the hydrogenation catalyst. Arsenic represents a particularly severe catalyst poison, which in small amounts already reduces the hydrogenation action of sulphur-resistant catalysts.

### STATE OF THE ART

A series of catalysts is known in the state of the art, which are used in the processes for the production of hydrocarbons from contaminated hydrocarbons.

Thus DE102008022098 discloses a hydrodemetallisation catalyst which permits demetallisation and which includes inter alia dehalogenation, desulphurisation, denitrification, olefin saturation, deposit of organic phosphorus, organic silicon compounds and conversion of the oxygen compounds from the hydrocarbon flow.

The preferred composition of the hydrodemetallisation catalyst used in the above-described processes is an inorganic oxide material. Porous or non-porous catalysts can be inter alia: silicon dioxide, alumina, titanium dioxide, zirconium dioxide, carbon, silicon carbide, silicon dioxide-alumina, diatomaceous earth, clay, magnesium oxide, activated carbon and molecular sieves. Silicon dioxide-alumina is a material which can be amorphous or crystalline and comprises silicon dioxide structural units which however not only represent a physical mixture of silicon dioxide and alumina. A mixture of various hydrodemetallisation catalysts can be used in dependence on the material source for the hydrocarbon charge flow. A complex hydrocarbon charge flow mixture can require a mixture a catalysts by virtue of the nature of the solids and metals to be deposited. In another embodiment the catalyst includes a metal deposited on the inorganic oxide material.

Suitable metals deposited on the support for hydrodemetallisation activity (in the form of chemical compounds of those metals) are inter alia those of groups VIB and VIIIB of the periodic table of elements, for example a metal from the group consisting of chromium (Cr), molybdenum (Mo), tungsten (W), iron (Fe), ruthenium (Ru), osmium (Os), cobalt (Co), rhodium (Rh), iridium (Ir), nickel (Ni), palladium (Pd) and platinum (Pt). The amount of the active metallic component is dependent on the respective metal and the physical and chemical properties of the respective hydrocarbon charge material. The metallic components selected from group VIB are generally present in an amount of from 1 to 20 percent by weight of the catalyst, while the metallic components of the iron group of group VIII are generally present in an amount of from 0.2 to 10 percent by weight of the catalyst, and the noble metals of group VIII are generally present in an amount of from 0.1 to 5 percent by weight of the catalyst. It is further provided that the hydrodemetallisation catalyst can include at least one of the following components: caesium, francium, lithium, potassium, rubidium, sodium, copper, gold, silver, cadmium, mercury and zinc.

The hydrodemetallisation catalysts known to the average man skilled in the art however only allow indescribably bad running times of the technical installation if the non-organic constituents of the contaminated hydrocarbons such as for example sediments and compounds of phosphorus are so considerably high that they lead to rapid bed clogging and deactivation of the hydrodemetallisation catalyst in the first reactor and poisoning of the hydrotreatment catalyst in the second reactor. The inorganic constituents trigger severe hindrances in terms of installation operation. Such serious disadvantages are:
clogging of the catalyst bed with inorganic sediments, which leads to a high differential pressure and premature shutdown of the installation and to a change in the reactor fillings,
poisoning of the hydrogenation catalysts due to the inorganic components like P, As, Pb and further metals,
issue of inorganic products if they pass through the catalyst layers and transfer into the waste water which is thereby contaminated with increased levels of concentration of harmful substances, and cannot be disposed of in the normal way, and
a reduction in product qualities due to a fall in catalyst activity.

In accordance with EP 0435310 A1, to catch inorganic impurities from sulphur-bearing flows shaped catalyst bodies are used as demetallisation catalysts, being based on aluminium oxide or alumosilicate as the support, which contain nickel and/or cobalt in combination with molybdenum or tungsten compounds which are present in the reaction atmosphere in the form of Ni₃S₂ or Co₉S₈ and MoS₂ or WS₂ respectively. To increase the absorption of dirt or inorganic fine particles the gap volume between the shaped bodies is increased by profiling of the catalyst shapings, for example by adopting a ring profile or a three-armed profile which is rotated about the longitudinal axis. To trap the catalyst poison arsenic from arsenorganic compounds, compositions with a high nickel content are used in order to bind arsenic in the form of NiAs.

Similar compositions, specific surface areas and pore sizes are referred to for the removal of contaminants for example in WO/2004/101713 A1 and U.S. Pat. No. 6,759,364. Those hydrogenation catalysts derived from the usual sulphur-resistant hydrorefining catalysts have specific surface areas of over 10 m2/g, generally between 150 and 300 m2/g, they are narrow-pored and they are not capable of collecting large amounts of inorganic material in their interior, and they absorb little phosphorus from volatile phosphorus compounds. When using such catalysts for the hydrogenating processing of hydrocarbons which contain large amounts of organic phosphorus compounds and organically bound metals the organic phosphorus and metal compounds are not retained sufficiently long before the actual hydrogenation catalyst. The hydrogenation catalyst is quickly poisoned, deactivated and does not achieve sufficiently long operating times. Replacement of the expensive catalyst fillings is required after just a relatively short time.

In accordance with DE 102007011471OS, a catalyst combination for the hydrogenation processing of contaminated hydrocarbon flows is known, in which a catalyst for hydrodemetallisation, which involves a bimodal pore distribution is used in the first reaction zone. It contains pores of a diameter of 3 to 10 nm with a pore volume of 0.25 to 0.35 cm³/g and additionally pores of a diameter of 1000 to 10000 nm=1.0 to 10 μm=0.001 to 0.01 mm with a pore volume of 0.25 to 0.35 cm³/g. Even that catalyst cannot absorb the considerably large amounts of metals and phosphorus as the pore volume and the pore diameters available for absorbing the inorganic compounds are not sufficiently large, the pores become quickly clogged at their pore openings and some reactants from the hydrogenated hydrocarbon flows like phosphorus compounds cannot react in an adequate amount with the chemical composition of the catalyst mass.

EP 0260826 A1 describes catalysts or precursors thereof comprising a ceramic body with a foam structure. The catalysts are suitable for various purposes and include inter alia aluminium oxide and an alkali metal oxide. In addition the material can also contain hydrogenating metal compounds. The described catalysts however are not suitable for absorbing dirt and catalyst poisons and are not provided for that purpose.

In accordance with DE 10134524OS, catalyst supports on an aluminium oxide/silicate base are known, which in the macro- and microrange, have a directed continuous pore structure. That process substantially provides that masses in slip form on an aluminium oxide/silicate base are foamed up using usual modifying agents, binding agents and thixotropic agents, at temperatures below 100° C. and at pH-values of 7 to 12, with metal pastes or powders. the foamed-up ceramic material is then dried and calcined at temperatures of 900 to 1800° C. That catalyst support however has no effectiveness for the conversion of organic heteroatom compounds and fixing of the resulting compounds so that the catalyst poisons still pass into the bed of the hydrogenation catalyst.

In accordance with EP 10001837 A1, the use of a layer of supermacroporous ceramic material, inter alia based on silicon dioxide-aluminium oxide, is known for absorbing solid particulate foreign bodies from contaminated hydrocarbon flows in a hydrorefining installation. That ceramic material can also contain a coating of porous aluminium oxide and a metal from group VIB or VIII.

Those materials are pre-eminently suited to accumulating solid inorganic compounds in large pores, for example inorganic Si-bearing sediments, particles of zinc phosphate or zinc phosphide, but they in contrast are not suitable for converting and then absorbing larger amounts of phosphorus from volatile phosphororganic compounds or phosphine compounds and dissolved metallorganic compounds. The latter pass through the guard bed of porous ceramic and continue to reduce the effectiveness of the hydrogenation catalysts arranged thereafter. The arrangement of such a protective layer admittedly extends the operating time of a catalyst filling, but technically it is still not satisfactory.

EP 0412862 A1 describes a nickel-based absorbent for the removal of phosphorus and arsenic from liquid hydrocarbon fractions. That invention concerns a material for the absorption of phosphorus comprising 40 to 97% by weight of a porous support which in turn contains 40 to 98.5% by weight of aluminium oxide and 1.5 to 60% by weight of oxides of Mg, Ca, Sr, Ba, Mn, Fe, Co, Ni, Cu and Zn, dissolved in the aluminium oxide, and, with respect to the total composition, 3 to 40% by weight of nickel oxide which is put on the carrier by exchange or deposit and is not converted into aluminate. The materials are thermally activated generally at 600° C. or between 750 and 800° C. After that, they are used for the treatment of preferably liquid hydrocarbon fractions at temperatures between 110 and 280° C. and at 1 to 100 bars in a hydrogen atmosphere.

The absorption materials produced in accordance with EP 0412862 are capable of reducing the phosphorus content to <100 ppb over a period of 500 hours, from a hydrocarbon flow which for example contains 500 ppb of phosphorus in the form of trimethyl phosphine and 500 ppm of sulphur in the form of organosulphur compounds. In the presence of larger amounts of sulphur and in the case of longer operating times that catalyst however loses it activity and can absorb only little phosphorus as the nickel is converted into nickel sulphide and/or nickel arsenide and then no longer represents a stable sulphur-resistant hydrogenation component for the hydrogenating conversion of the phosphororganic compounds.

In addition US4582595 describes a process for the hydrogenation processing of heavy oils using a sepiolite-based catalyst of the chemical composition Mg₈[(OH)₂|Si₆O₁₅]₂.xH₂O.

U.S. Pat. No. 5,645,804, GB 2249194-A, EP 513469-A and WO 2010/089346-A further disclose ceramic materials based on magnesium-iron-alumosilicates, which however are used for other purposes of use such as exhaust gas cleaning. The catalysts described there, with the metals Cu, Co, Ni, Fe and V do not meet the demands on catalyst materials for the hydrogenation process of liquid sulphur-bearing hydrocarbon fractions in the presence of hydrogen, as the metal components used are not sulphur-resistant.

### OBJECT OF THE INVENTION

Therefore there is a high demand for a material which in comparison with the materials known from the state of the art has improved properties in regard to binding or absorbing dirt particles and in regard to the preliminary hydrogenation treatment of phosphororganic, arsenorganic and metallorganic compounds. Therefore the object of the invention is to provide a novel material for the hydrogenation treatment of hydrocarbons severely contaminated with inorganic constituents, which protects the actual hydrogenation catalyst from a reduction in its activity.

It was surprisingly found by the inventors that the object of the invention can be attained by the provision of a novel catalytically active ceramic material which acts as an adsorbent and which can both absorb fine dirt particles and also convert dissolved heterohydrocarbon compounds and also metallorganic compounds in a chemical-hydrogenating procedure and can fix the elements from the resulting substances which are harmful to the hydrogenation catalyst so that the main hydrogenation catalyst is durably protected.

In particular the combinations which can be used according to the invention of compounds of elements from group VIIIB of the periodic table of elements (PTE) like cobalt and/or nickel as well as compounds of elements from group VIB of the periodic table like molybdenum and/or tungsten are effective. The good hydrogenation capability of the catalyst in the presence of sulphur compounds is also the prerequisite for a long-persisting capability for the hydrogenation cracking of metal-carbon bonds to provide for effective demetallisation.

In accordance with the present invention there is provided a completely unusual combination of compounds of elements from group VIB of the periodic table like molybdenum and/or tungsten and optionally compounds of elements from group VIIIB of the periodic table like cobalt and/or nickel, with alkali metal compounds in the selected ranges of concentration on an alumosilicate support, the use of which is rejected by the men skilled in the art in the state of the art. It is generally known that a sulphur-resistant hydrorefining catalyst or hydrocracking catalyst may contain only very low levels of concentration of alkali metal compounds because they reduce activity or alkali metal compounds in such catalysts act as activity dampers. In the state of the art for example the content of Na₂O in hydrorefining catalysts and hydrocracking catalysts is limited to levels of concentration of below 0.3, preferably even to below 0.03% by weight. If an amorphous alumosilicate is used as the support component, the alkali ions present in manufacture are thoroughly washed out to limit the content thereof to a minimum.

According to the invention it is correspondingly more surprising that an effective hydrorefining catalyst can be produced, using the levels of concentration according to the invention of alkali metal oxides, combined with an alumosilicate, which in addition is also effective for the hydrogenating reduction in metallorganic compounds and can absorb the inorganic impurities in the catalyst.

A further advantage of the combination according to the invention is also demonstrated, in comparison with known demetallisation catalysts, in the examples, by the surprisingly high absorption capability for phosphorus, lead, arsenic and other inorganic impurities which represent known catalyst poisons.

Production of the catalyst using alkali metal compounds in combination with the hydrogenation metals Ni and/or Co and Mo and/or W is novel and inventive and it was not to be foreseen in such a way that good distribution of the metal components occurs thereby and an effective catalyst can be produced.

### DESCRIPTION OF THE INVENTION

The invention thus proposes a catalytically active material with adsorption properties for the removal of non-hydrocarbon compounds in fixed-bed hydrogenation processes, based on ceramic, supermacroporous alkali alumosilicate which additionally can be charged with one or more hydrogenation components selected from compounds of elements of group VIB and group VIIIB of the periodic table.

More precisely the invention concerns a novel, catalytically active ceramic material which acts as an adsorbent and which can be obtained by charging ceramic particles, preferably alumosilicate particles, with through pores of 0.01 to 3.0 mm in diameter, in one or more process steps, with one or more compounds of elements of the 1st main group and possibly also with one or more compounds of elements of group VIB and/or VIIIB of the periodic table and/or incorporating same into said ceramic particles and by subsequently treating the particles treated in that way thermally at temperatures of 300 to 800° C., wherein the preferably hydrogenation component-bearing, supermacroporous alkali alumosilicate according to the invention is formed.

Charging with and/or incorporation of compounds of elements of the 1st main group, group VIB and/or group VIIIB of the periodic table on the ceramic particles can be effected in one or more stages with interposed thermal treatment operations.

Preferably the ceramic alumosilicate particles are impregnated with a solution of an alkali metal compound and then subjected to thermal post-treatment at temperatures of 300 to 800° C. and if desired the alkali alumosilicate obtained can be impregnated with compounds of elements of group VIB and/or group VIIIB of the periodic table of elements and then again subjected to thermal post-treatment at 350 to 600° C.

The alkali alumosilicate presented can be produced for example by producing a slip of aluminium oxides and silicates by mixing the components in powder form with water and additives for stabilisation, and stirring in air, with the formation of fine cavities in bubble form, pouring the material in moulds and slowly drying it to remove the water, in which case the pervading pore system of large pores is formed and the dried mouldings are calcined at temperatures between 900 and 1800° C. with the formation of mullite. The manufacture of such similar materials which are known as foam ceramic is generally known to the men skilled in the art.

The starting compounds or materials are used in the processes according to the invention in such amounts that the catalytically active adsorbent materials defined in the product claims can be produced with the % by weight specified therein.

The supermacroporous alumosilicate produced in that way can then be impregnated after production in the form of alumosilicate preferably with a mullite structure, with the alkali metal compound and subjected to thermal post-treatment. It is however also possible to introduce an alkali metal compound into the slip so that the desired concentration of the alkali metal compounds in the above-specified range is already achieved. Advantageously the supermacroporous alumosilicate is treated by means of the process for impregnation with a preferably aqueous solution of one or more alkali metal salts which in the subsequent thermal treatment decompose and give the respective corresponding alkali metal oxide which reacts with the ceramic alumosilicate to give alkali alumosilicate. That treatment can be performed in one or more stages and can thus be in the form of simultaneous treatment with a plurality of alkali metal salts in one stage or as a treatment with a respective alkali metal salt in a plurality of stages. The amount of alkali metal salt solution is of such a concentration and size that the desired content of alkali metal in the alkali alumosilicate is achieved. For that purpose the amount of the solution should be completely accommodated by the ceramic alumosilicate.

The invention is thus directed to a catalytically active adsorbent material for the removal of non-hydrocarbon compounds in fixed-bed hydrogenation processes based on ceramic porous alkali alumosilicate as a support material, with:
a content of aluminium oxide of 20 to 95% by weight,
a content of silicon dioxide of 5 to 80% by weight,
a content of 0.5 to 30% by weight of oxides of elements of the 1st main group of the periodic table, and
pores of a diameter of 0.01 to 3.0 mm,
   wherein the % by weight are respectively related, calculated as oxides, to the water-free overall weight of the adsorbent material.

The catalytically active material according to the invention can, independently of each other, have in particular a content of aluminium oxide of 20 to 60% by weight, quite particularly 20 to 40% by weight, silicon dioxide of 30 to 70% by weight, quite particularly 50 to 70% by weight, and 1 to 20% by weight, and quite particularly 5 to 20% by weight of oxides of elements of the 1st main group of the periodic table, wherein the % by weight are respectively calculated as oxides in relation to the water-free overall weight of the catalytically active material.

In addition the catalytically active material according to the invention can have a content of oxidic compounds which do not detrimentally influence the catalytic activity and adsorbent properties such as metal oxides of calcium, iron etc, in an individual amount of respectively at most 2% by weight, particularly at most 1% by weight, and an overall amount of less than 5% by weight, in particular at most 3% by weight. In the case of all compositions specified in the context of this description, the amounts of the individual constituents in % by weight are added to give 100% by weight of the water-free overall weight.

Although the material according to the invention already implements a catalytic activity without charging with hydrogenation metal, in particular due to the metals contained in the hydrocarbons as impurities, the material according to the invention can further include, to enhance catalytic activity, a content of from more than 0 to 10% by weight of molybdenum and/or tungsten and in addition optionally from more than 0 to 10% by weight of nickel and/or cobalt, in each case calculated as oxide, wherein the % by weight is related in each case to the water-free overall weight of the catalytically active material.

In an embodiment the catalytically active material can have a content of 6 to 10% by weight of molybdenum and/or tungsten and additionally optionally a content of 1 to 5% by weight of nickel and/or cobalt, in each case calculated as oxide and in relation to the overall weight of the material.

The alkali alumosilicate according to the invention can be present in the form particles of 2 to 50 mm in size in the form of cubes, cuboids, discs, bars of round or profiled diameters, hollow bodies, balls or bodies which are shaped in the form of an egg or which are irregularly shaped, the shape and size of which can be selected according to the desired application.

The alkali alumosilicate according to the invention which is impregnated in that way has a pore volume of 0.6 to 1.5 cm³/g, preferably 0.8 to 1.2 cm³/g, wherein the pores are of a diameter of 0.01 to 3.0 mm, preferably 0.05 to 2.0 mm. The specific surface area of the alkali alumosilicate according to the invention is below 50 m²/g, in addition below 25 m²/g, in particular below 10 m²/g, quite particularly preferably below 6 m²/g and particularly preferably below 2 m²/g.

In the alkali alumosilicate produced according to the invention the ratio of SiO₂ to Al₂O₃ is from 5:95 to 80:20, in particular 10:90 to 60:40, expressed in % by weight. Compounds of elements of the 1st main group of the periodic table of elements such as Li₂O, Na₂O, K₂O, Rb₂O and/or Cs₂O are suitable as alkali constituents of the alumosilicate. The alkali metal compounds for treatment or incorporation adopted are compounds which after the calcination operation give Li₂O, Na₂O, K₂O, Rb₂O and/or Cs₂O, and react with the ceramic alumosilicate to give alkali alumosilicate. In particular the nitrates, hydroxides, carbonates, silicates and salts of organic acids are suitable as the alkali metal compounds. Depending on the respective purpose of use of the alkali alumosilicate produced according to the invention, in an embodiment, contains 0.5 to 30% by weight, in a further embodiment it contains 1 to 20% by weight and in another embodiment it contains 5 to 20% by weight of alkali metal oxide, in particular Na₂O and/or K₂O, in relation to the dried and calcined alkali alumosilicate.

As mentioned the alkali alumosilicate produced according to the invention can be charged with hydrogenation metal compounds, preferably with elements of group VIB such as chromium, molybdenum, tungsten and group VIIIB of the periodic table of elements (PTE) like iron, cobalt, nickel and also combinations thereof, wherein the content of hydrogenation metals can preferably be up to about 20% by weight, advantageously up to 10% by weight, with respect to the dried and calcined alkali alumosilicate. Molybdenum and/or tungsten and additionally optionally nickel and/or cobalt are advantageous. The combination of Mo—Ni or W—Ni is particularly advantageous. For introducing those metals, for example by impregnation of the solid support particles with solutions of salts of the hydrogenation metals, it is possible to use processes which are well known to the men skilled in the art. It is also possible for the alkali metal or mixtures thereof to be introduced in the form of compounds simultaneously with the hydrogenation metals, by impregnation.

For example an aqueous solution of ammonia with the amount of ammonium dimolybdate and nickel carbonate and, if required, a thermally decomposable alkali metal compound such as sodium carbonate can be mixed in the desired quantitative ratios and adjusted to the necessary volume corresponding to the total pore volume of the alkali alumosilicate or alumosilicate to be treated. It is also possible for the alumosilicate or alkali alumosilicate to be mixed with individual solutions of the individual catalytically active hydrogenation metal salts if the sum of the individual solutions corresponds to the overall pore volume of the material and the solutions are completely absorbed by the material. In particular according to the invention therefore the solutions of alkali metal and if used hydrogenation metal are used in an overall volume corresponding to the total pore volume of the alkali alumosilicate or alumosilicate to be treated. Depending on the respectively desired weight ratio of the metals relative to each other the solutions can be used in appropriate levels of concentration and amounts. After drying of the material treated in that way calcination can then be performed in the next step.

Charging with hydrogenation metals and with alkali metals can advantageously also be effected in an impregnation step and subsequently calcination at temperatures up to 600° C.

The nature of the charging operation in respect of the solid particulate functional combination of catalyst and absorption agent with compounds of elements of the 1st main group and group VIB and/or group VIIIB of the PTE in terms of concentration and composition can be varied in dependence on the inorganic components of the contaminated hydrocarbon oil used, using the knowledge of the average men skilled in the art. According to the invention therefore it is possible to produce a layer of alkali alumosilicate on the surface of the alumosilicate, which extends at least partially over the surface of the porous alumosilicate including the pores and passages in the interior thereof and which, in the inventors' view, appears to be responsible primarily for the surprising properties of the supermacroporous alkali alumosilicate according to the invention.

The alkali alumosilicate used according to the invention, if it contains the hydrogenation metals of group VIB and/or VIIIB of the PTE, is sulphidized prior to use in accordance with known methods, for example by treatment with a mixture of hydrogen and hydrogen sulphide, or by impregnation with organosulphuric compounds. It can however also be sulphidized in situ by presenting sulphur compounds in a hydrogen atmosphere. It can however also be used immediately and with a high H₂S partial pressure the compounds of metals of group VIB and VIIIB of the PTE are converted into sulphides. After that the metals are present in the form of their sulphides which in the corresponding combinations represent sulphur-resistant hydrogenation catalysts. The reaction conditions in the improved process to be applied are usual and are known to the man skilled in the art:

overall pressure: 5 to 200 bars

H₂ content of the KLG: 50 to 90% by volume

throughput: 3 to 8 m³ per kg of catalyst in the 3rd zone

temperatures: 300 to 560° C., preferably 300 to 360° C.

The pores of the usual demetallisation catalysts are generally of a diameter of 0.001 to 0.05 μm and are not in a position to collect and fix solid particles and large amounts of metal compounds from the hydrocarbon flows. That is only ensured by the application of the alkali alumosilicates according to the invention.

A particular advantage of the alkali aluminate-foam ceramic according to the invention is that it has large pores and a high pore volume, whereby the transport reactions into the interior of the particles is not impaired. Thus even large molecules and agglomerated fine inorganic dusts can be flushed into the interior of the individual particles and filtered out of the hydrocarbon flow. In contrast to the usual demetallisation catalysts therefore there are no restrictions by virtue of the use of larger particles of the alkali aluminate-foam ceramic involving dimensions of up to several centimeters. The gap volume which occurs in the bulk fill can in addition further be used for transport of the oil and the hydrogen in the reactor, after saturation of the pores with dirt particles, and is filled up to the end of the operating period with further dirt particles. This therefore also avoids the premature development of detrimental pressure differences in the installation.

In that form the alumosilicate according to the invention is suitable as a catalytically active material which can be used prior to the actual hydrogenation catalyst in the catalyst bed and which has an adsorbing action in the hydrocarbon flow. Thus it protects the actual hydrogenation catalyst from the contaminating materials and catalyst poisons and is thus in a position for protecting the main catalyst for hydrogenation of the hydrocarbon flows by absorption of dirt particles, colloidally disperse substances and catalyst poisons, from any hydrocarbon-bearing waste flows, crude oil, hydrocarbon flows of natural or synthetic origin, which in particular are severely contaminated with inorganic components and heteroatom compounds.

Any hydrocarbon-bearing waste flows can be used as the hydrocarbon-bearing substrate. The material according to the invention can advantageously be used for the hydrogenation cleaning of used engine oils.

The used engine oil generally contains 1 to 3% by weight of zinc dialkyl dithiophosphate as well as further additives such as for example calcium sulphonate. During use in the engine the engine oil absorbs further metal compounds of lead, iron, chromium and copper.

In the hydrogenation process the additive contained in the engine oil, zinc dialkyl dithiophosphate, or the phosphorus-bearing decomposition products thereof, at least partially pass with the vaporisable hydrocarbons into the reactor units (deposit and reaction zones) and is immediately deposited in the first zone as an inorganic compound. In the second reaction zone the volatile phosphororganic decomposition products of the zinc dialkyl dithiophosphate are converted in hydrogenating fashion and compounds like phosphoric acid and phosphine are chemically bound to the combination of catalyst and absorption agent, consisting of macroporous alkali alumosilicate.

In addition the oil contains metallorganic compounds, for example of zinc, iron, chromium, copper, vanadium and arsenic. Some of those represent poisons for the hydrogenation catalysts. They are also decomposed at the combination of catalyst and absorption agent consisting of macroporous alkali alumosilicate and are partially incorporated into the chemical structure of the alkali alumosilicate or are deposited after hydrogenating decomposition thereof, under the action of H₂₅ and phosphorus compounds, as sulphides, phosphides and phosphates in the interior of the large passages in the particles of the alumosilicate according to the invention.

Compounds of elements of group VIB and group VIIIB of the PTE, which are disposed on the inside surface of the large pores in the particles, continue to also transmit their hydrogenation action by way of the layers of the inorganic metal compounds deposited during the procedure, to the hydrogenatingly decomposable hydrocarbon-heteroatom compounds so that conversion in the pores which are highly accessible by virtue of their size can continue to proceed still longer. As soon as the large pores are filled with deposits dirt can also be deposited in the gap volume of the catalyst fillings until the penetrability through the catalyst bed leads to an excessive differential pressure increase. The phosphorus obtained is primarily bound by the alkali alumosilicate; in addition phosphorus can also be bound by the hydrogenation metals applied in manufacture and by the metals incorporated during the process like zinc, iron, nickel and copper.

Organic chlorine compounds are at least partially converted to HCl and are also absorbed by the catalytically active material according to the invention.

The alkali alumosilicate can also be used without charging with compounds of elements of group VIB and group VIIIB of the PTE. Then large of phosphorus compounds are always still absorbed from the hydrocarbon flow of used engine oil. The metals deposited in the large pores of the alkali alumosilicate such as for example zinc, nickel and vanadium in the form of sulphides and phosphides can also become catalytically active and cause further hydrogenation of metallorganic compounds. The hydrogenation action is also not reduced or completely suppressed by the presence of absorbed arsenic or lead, but the hydrogenation metals applied on the inner surface in the production process also still transmit their hydrogen-activating action to the molecules flowing therethrough.

With the alkali alumosilicates used phosphorus and arsenic are presumably not fixed at the hydrogenation metals like nickel but in a far greater amount in the alumosilicate body, in which respect the absorption mechanism could not yet be clearly elucidated. As arsenic can be absorbed by the alkali alumosilicate-foam ceramic even when it is combined with only low hydrogenation metal contents, this gives an additional advantage by virtue of the avoidance of large amounts of heavy metal in the protective catalyst used, in particular when it is used as an arsenic trap.

The material according to the invention can also be used in hydrogenation processes for the decontamination of oils containing nickel and vanadium porphyrins. In that case the material serves as a protective filter in conventional fixed-bed reactors (top layer). In such cases it protects the main catalyst from fouling and poisoning by arsenic, nickel and vanadium compounds.

The invention is described in fuller detail hereinafter by means of the following Examples.

### Example 1

To produce the samples of alkali alumosilicate a commercially available foam ceramic having the following properties was modified by charging with alkali metal and if specified hydrogenation components. The composition is specified in % by weight with respect to water-free substance in Table 1.

Properties of the commercial foam ceramic
(Table 1: sample 1, fresh)

| shape | cube with edge lengths 2 × 2 × 5 cm | |
|---|---|---|
| accessible pore volume | 1.00 cm³/g | |
| pore diameter distribution | 100 to 300 μm | 20% of pore volume |
| | 300 to 800 μm | 50% of pore volume |
| | 800 to 2000 μm | 30% of pore volume |
| particle density | 0.75 g/cm³ | |
| charge density | 440 kg/m³ | |
| specific surface area | 1 m²/g | |

The following samples were produced on the basis of the above-mentioned foam ceramic and incorporated into the bed of a commercial demetallisation catalyst in a hydrogenation installation:
A: untreated commercial foam ceramic of the above-specified composition
B: commercial low-alkali alumosilicate-foam ceramic charged with 3% of NiO+9% of MoO₃
C: commercial foam ceramic charged with 10% of Na₂O
D: commercial foam ceramic charged as specified with 5% of Na₂O and 3% of NiO+9% of MoO₃.

### Production of Sample B:

The above-mentioned commercial foam ceramic was impregnated with a solution of nickel nitrate and ammonium dimolybdate with simple water absorption by spraying of the solution on to the foam ceramic. The concentration of Ni and Mo in the solution was so selected that the target concentration of Ni and Mo in the foam ceramic was achieved by a defined amount of solution which was sprayed on. The particles treated in that way were dried for five hours and then calcined at 500° C. for three hours in a static furnace with removal of the gases produced.

### Production of Sample C:

The above-mentioned commercial foam ceramic was impregnated with a solution of 10% by weight of Na₂CO₃ with respect to the overall composition by spraying on the solution, dried at 100 to 120° C. for three hours and calcined at 800° C.

### Production of Sample D:

The above-mentioned commercial foam ceramic was impregnated with a solution of 5% by weight of Na₂CO₃ with respect to the overall composition by spraying on the solution, dried at 100 to 120° C. for three hours and calcined at 800° C. It was then impregnated with a common solution of nickel nitrate and ammonium dimolybdate by spraying on so that the target concentration was achieved.

Samples A and B are not according to the invention, Samples C and D are additionally charged with alkali metal and are according to the invention.

### Example 2

Samples A to D were incorporated into the bed of a commercial demetallisation catalyst in a technical installation as test samples of a litre respectively for hydrogenation of a used engine oil.

Those samples, like the entire demetallisation catalyst, had the hydrocarbon oil flowing therethrough during the entire operating time of the catalyst and, after the end of the period of operation, were removed with the demetallisation catalyst and investigated by X-ray fluorescence analysis.

After dismantling the materials were investigated for inorganic constituents by means of X-ray fluorescence analysis, after sieving off the dust deposited in the gap volumes. The analysis results are set out in Table 1.

It is shown that the effectiveness of the material for the absorption of phosphorus can be substantially enhanced by the alkali metal charging of the alumosilicate-foam ceramic. Sample A contains only little native alkali metal oxides. The pores thereof evidently adsorptively receive zinc-phosphorous compounds finely distributed in the oil. In contrast the additionally alkali-charged alumosilicate-foam ceramic C and in particular the alkali alumosilicate-foam ceramic D also additionally charged with hydrogenation metal compounds has an even substantially greater acceptance of phosphorus.

The inventors found that the lubricating oil additive zinc dialkyl dithiophosphate is broken down, wherein zinc forms with phosphorus an inorganic compound, in which zinc and phosphorus are in an atomic ratio of 1:1. Zinc and phosphorus are then insoluble in the oil and are deposited in the form of a zinc-phosphorus compound in the catalyst. In addition, in the breakdown of the organic zinc compound, further phosphorus compounds which contain no zinc are produced. The latter are not sufficiently absorbed by the previously known demetallisation catalyst and, after the hydrogenation catalysts are saturated with phosphorus, they move with the oil through the reactor and finally appear in the hydrogenation product. The alkali alumosilicate however can chemically bind those free phosphorus compounds.

In addition the hydrogenation metal-charged alkali alumosilicate also functions as a catalyst for decomposition of metallorganic compounds, for example lead, iron and copper. After the hydrogenating catalytic decomposition those metals remain in the form of sulphides or phosphides and are collected and fixed in the large pores in the alkali alumosilicate-foam ceramic. Furthermore additional zinc is also deposited in the form of a fixed compound which presumably also occurred in the form of a metallorganic compound.

All those inorganic substances are collected by the alkali alumosilicate materials prior to the actual hydrogenation catalyst and protect the latter from premature poisoning. That makes it possible to comply with the quality indices of the oil over a much longer period of time.

TABLE 1
Composition of the removed conventional demetallisation catalyst and the installed samples of Examples 1 and 2
Composition in % by weight relative only to inorganic constituents, calculated as oxides

| | Demetallisation | Demetallisation | Sample A | Sample A | Sample B | Sample B | Sample C | Sample C | Sample D | Sample D |
|---|---|---|---|---|---|---|---|---|---|---|
| Constituents | catalyst fresh | catalyst used | fresh | used | fresh | used | fresh | used | fresh | used |
| SiO₂ | | | 66.3 | 55.4 | 58.4 | 46.0 | 59.2 | 37.7 | 55 | 25.5 |
| Al₂O₃ | | | 26.9 | 22.1 | 24.0 | 20.5 | 24.0 | 15.3 | 22 | 10.2 |
| support | 82.0 | 70.8 | | | | | | | | |
| component | | | | | | | | | | |
| Na₂O | | 0.1 | 1.8 | 1.4 | 1.6 | 1.2 | 11.6 | 7.5 | 5 | 2.6 |
| K₂O | | | 4.4 | 3.6 | 3.0 | 2.3 | 3.9 | 2.4 | 3.0 | 1.3 |
| CaO | | 0.2 | 0.3 | 0.2 | 1.0 | 0.1 | 0.2 | 0.6 | 1.0 | 2.2 |
| NiO | | | | | 3.0 | 2.3 | | | 3.1 | 1.3 |
| MoO₃ | | | | | 8.0 | 6.3 | | | 9.1 | 4.0 |
| oxidic | 18.0 | 15.7 | | | | | | | | |
| hydrogenation | | | | | | | | | | |
| component | | | | | | | | | | |
| FeO | | 0.1 | 0.2 | | | 0.3 | 0.5 | 0.7 | 0.5 | 0.8 |
| P₂O₅ | | 10.0 | | 15.0 | | 16.0 | 0.1 | 32.0 | | 44.8 |
| ZnO | | 2.1 | | 1.5 | | 2.4 | | 1.8 | | 3.2 |
| CuO | | | | | | 0.1 | | | | 0.1 |
| PbO | | | | | | 1.0 | | 1.3 | | 1.6 |
| Cl | | | | | | | | | | 1.0 |
| others | | | | 0.5 | 1.0 | 1.5 | 0.2 | 0.6 | 0.3 | 0.5 |
| sum | | | 100 | 99.8 | | 100.0 | 99.8 | 100 | | |
| absorption of | | 14 | | 20 | | 25 | | 57 | | 125 |
| inorganic substances | | | | | | | | | | |
| calculated as oxides | | | | | | | | | | |
| in g/100 g catalyst | | | | | | | | | | |

### Example 3

This Example describes in greater detail the absorption of the phosphorus-like element arsenic, which has a particularly severe poisoning effect on the hydrogenation catalysts, by means of the hydrogenation metal-charged alkali alumosilicate-foam ceramic according to the invention.

The dismantled samples from Example 2 were freed of dust by sieving off. The arsenic content of the removed demetallisation catalyst, the dust deposited in the gap volume of the catalyst bed and the alkali alumosilicates C and D according to the invention were determined exactly in mg As/kg(ppm), with respect to the disassembly mass. In that case the values set forth in Table 2 were obtained.

The result shows that the hydrogenation metal-charged alkali alumosilicate-foam ceramic D used according to the invention is capable of absorbing five times more arsenic than a conventional demetallisation catalyst. That means that, with the use according to the invention of the hydrogenation metal-charged alkali alumosilicate-foam ceramic, much better protection for the hydrogenation catalysts from arsenic poisoning is also to be expected, than by the use of the conventional demetallisation catalysts.

TABLE 2
Contents of arsenic in mg/kg of original disassembly
material after use according to Example 2.

| | |
|---|---|
| Conventional demetallisation catalyst | 115 |
| foam ceramic sample A | 5 |
| foam ceramic sample C | 97 |
| foam ceramic sample D | 581 |
| dust | <17 |

1. A catalytically active material for the removal of non-hydrocarbon compounds in fixed-bed hydrogenation processes on the basis of porous ceramic alkali alumosilicate as support material, comprising:
a content of aluminium oxide of 20 to 95% by weight,
a content of silicon dioxide of 5 to 80% by weight,
a content of 0.5 to 30% by weight of oxides of elements of the 1st main group of the periodic table of elements,
a content of oxidic compounds which do not detrimentally influence the catalytic activity and adsorbent properties, in an individual amount of respectively at most 2% by weight and an overall amount of less than 5% by weight,
pores of a diameter of 0.01 to 3.0 mm,
wherein the % by weight are respectively related, calculated as oxides, to the water-free overall weight of the catalytically active material.

2. A catalytically active material according to claim 1, comprising a content of 1 to 20% by weight, of oxides of elements of the 1st main group of the periodic table of elements, wherein the % by weight are respectively related to the water-free overall weight of the catalytically active material.

3. A catalytically active material according to claim 1, further comprising a content of from more than 0 to 10% by weight of molybdenum and/or tungsten and optionally from more than 0 to 10% by weight of nickel and/or cobalt, respectively calculated as oxide, wherein the % by weight are respectively related to the water-free overall weight of the catalytically active material.

4. A catalytically active material according to claim 3, comprising a content of 6 to 10% by weight of molybdenum and/or tungsten and with a content of 1 to 5% by weight of nickel and/or cobalt, respectively calculated as oxide and relative to the overall weight of the material.

5. A catalytically active material according to claim 1 wherein the pores have a diameter of 0.05 to 2.0 mm.

6. A catalytically active material according to claim 1 having a pore volume of 0.6 to 1.5 cm³/g.

7. A catalytically active material according to claim 1, having a specific surface area of below 50 m²/g.

8. A process for the production of the catalytically active material according to claim 1, wherein compounds of elements of the 1st main group of the periodic table of elements, which after calcination give Li₂O, Na₂O, K₂O, Rb₂O and/or Cs₂O and react with the ceramic alumosilicate to alkali alumosilicate, are incorporated into alumosilicate ceramic particles with through pores of 0.01 to 3.0 mm in diameter, in levels of concentration of 0.5 to 30% by weight, and the particles charged in that way are subjected to thermal post-treatment at temperatures of 300 to 800° C., wherein the % by weight, calculated in each case as oxides, are related to the water-free overall weight of the catalytically active material produced.

9. A process for the production of the catalytically active material according to claim 8, wherein in addition from more than 0 to 10% by weight of a molybdenum compound and/or a tungsten compound and optionally from more than 0 to 10% by weight of a nickel compound and/or a cobalt compound are incorporated into the alumosilicate ceramic particles and the particles charged in that way are subjected to thermal post-treatment at temperatures of 300 to 800° C., wherein the % by weight, calculated in each case as oxides, are related to the water-free overall weight of the catalytically active material produced.

10. A process for the production of the catalytically active material according to claim 9, wherein the alumosilicate ceramic particles are impregnated with the alkali metal compound, subjected to thermal post-treatment at temperatures of 300 to 800° C., and the resulting alkali alumosilicate is impregnated with more than 0 to 10% by weight of a molybdenum compound and/or a tungsten compound and optionally more than 0 to 10% by weight of nickel and/or cobalt, and again subjected to a thermal post-treatment at 350 to 600° C., wherein the by weight, calculated in each case as oxides, are related to the water-free overall weight of the catalytically active material produced.

11. A process according to claim 8, wherein the ratio by mass of SiO₂ to Al₂O₃ in the alkali alumosilicate is 5:95 to 80:20.

12. A process according to claim 8, wherein the alkali metal compound is used in an amount such that the alkali alumosilicate contains 0.5 to 30% by weight Na₂O and/or K₂O, wherein the by weight, calculated in each case as oxides, are related to the water-free overall weight of the catalytically active material produced.

13. (canceled)

14. A process for a hydrogenation treatment of hydrocarbons wherein the catalytically active material according to claim 1 is subjected to a sulfidisation process and the sulfidised catalytically active material is used in a fixed-bed hydrogenation process for a hydrogenation treatment of hydrocarbons contaminated with inorganic constituents.

15. A method for removing non-hydrocarbon compounds comprising treating of hydrocarbons with the catalytically active material according to claim 1 in a fixed-bed hydrogenation process, thereby removing non-hydrocarbon compounds.

16. A process for the production of the catalytically active material according to claim 1, comprising:
charging ceramic alumosilicate particles having through pores of 0.01 to 3.0 mm in diameter with an alkali metal compound of the first main group of the periodic table of elements at a concentration of 0.5 to 30% by weight; and
calcining the charged ceramic alumosilicate particles at temperatures of 300 to 800° C. to give an alkali metal oxide selected from the group consisting of Li₂O, Na₂O, K₂O, Rb₂O and Cs₂O, said alkali metal oxide reacting with the ceramic alumosilicate particles to give alkali alumosilicates,
wherein the % by weight, calculated in each case as oxides, are related to the water-free overall weight of the catalytically active material produced.
